(19) United States
(12) Patent Application Publication
(10) Pub. No.: US 2026/0135954 A1
(43) Pub. Date: May 14, 2026

(54) IMAGE FORMING APPARATUS, PROCESSING METHOD OF IMAGE FORMING APPARATUS, AND STORAGE MEDIUM

(71) Applicant: CANON KABUSHIKI KAISHA, Tokyo (JP)

(72) Inventor: KIICHI HASEGAWA, Kanagawa (JP)

(21) Appl. No.: 19/367,596

(22) Filed: Oct. 23, 2025

(30) Foreign Application Priority Data
Nov. 8, 2024 (JP) 2024-196161

(51) Int. Cl. H04N 1/00; H04L 51/04; H04L 51/10

(52) U.S. Cl. CPC H04N 1/00212; H04L 51/04; H04L 51/10

(57) ABSTRACT

An image forming apparatus includes at least one memory storing instructions, and at least one processor that, upon execution of the stored instructions, configures the at least one processor to operate as an uploading unit configured to, in a case where a reading instruction is given with a plurality of channels being selected as send destination channels, upload image data generated by reading an original image to a message application server and receive save location information about the image data from the message application server, and a sending unit configured to send a message including the save location information about the image data to each of chat rooms of the plurality of send destination channels of the message application server.

### BACKGROUND

### Field of the Technology

The present disclosure relates to an image forming apparatus, a processing method of an image forming apparatus, and a storage medium.

### Description of the Related Art

With the spread of cloud services, there are provided services that allow users to save scanned images from an image forming apparatus via a network to the cloud, and services that allow users to obtain print data saved in the cloud and print the obtained print data.

Japanese Patent Laid-Open No. 2021-99751 describes a technology by which a scan button is generated on an image forming apparatus in response to a scan instruction from a business chat, and when the scan button is pressed, the scanned image is transmitted to a business chat service that is a cloud service.

According to Japanese Patent Laid-Open No. 2021-99751, the generated image data is stored in a predetermined storage server, and link information about the stored image data is sent to a selected group via chat, thereby providing a notification to a plurality of users. For this reason, in the case of providing a notification on the same image data to a plurality of groups, it is necessary to send the notification to each group individually.

In addition, in some cloud services, the right of viewing images that are stored in the storage server may be linked to groups. In a business chat service based on this configuration, if the link information about the image data provided to a group by the notification unit described above is shared with another group, the participants of the other group will not be able to view the images because they do not have the viewing right.

### SUMMARY

The present disclosure is directed to sending a message including save location information about image data to each of chat rooms of a plurality of channels.

According to an aspect of the present disclosure, an image forming apparatus includes at least one memory storing instructions, and at least one processor that, upon execution of the stored instructions, configures the at least one processor to operate as an uploading unit configured to, in a case where a reading instruction is given with a plurality of channels being selected as send destination channels, upload image data generated by reading an original image to a message application server and receive save location information about the image data from the message application server, and a sending unit configured to send a message including the save location information about the image data to each of chat rooms of the plurality of send destination channels of the message application server.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration of an image forming system.

FIG. 2 is a diagram illustrating a configuration of a multi-function peripheral (MFP).

FIG. 3 is a diagram illustrating a configuration of a message application server.

FIG. 4 is a diagram illustrating a configuration of a user terminal.

FIG. 5 is a diagram illustrating a configuration of a tenant.

FIG. 6 is a sequence diagram illustrating an example of a sequence for providing image information to a plurality of channels.

FIG. 7 is a flowchart illustrating an example of a process flow for providing image information to the plurality of channels.

FIG. 8A and FIG. 8B are diagrams illustrating an example of channel designation screens displayed on the MFP for providing image information to the plurality of channels.

FIG. 9A and FIG. 9B are diagrams illustrating an example of chat screens for individual channels and chats with image information, which are displayed on a user terminal.

FIG. 10 is a sequence diagram illustrating an example of a sequence for providing image information to another channel based on a send history.

FIG. 11 is a flowchart illustrating an example of a process flow for providing image information to another channel based on a send history.

FIG. 12A, FIG. 12B, and FIG. 12C are diagrams illustrating an example of channel designation screens displayed on the MFP for providing image information to another channel from the send history.

### DESCRIPTION OF THE EMBODIMENTS

Hereinafter, preferred embodiments will be described below by way of example with reference to the drawings. However, it should be understood that modifications and improvements made to the embodiments described below based on the ordinary knowledge of those skilled in the art, also fall within the scope of the claims, provided that they do not deviate from the spirit of the present disclosure.

### First Embodiment

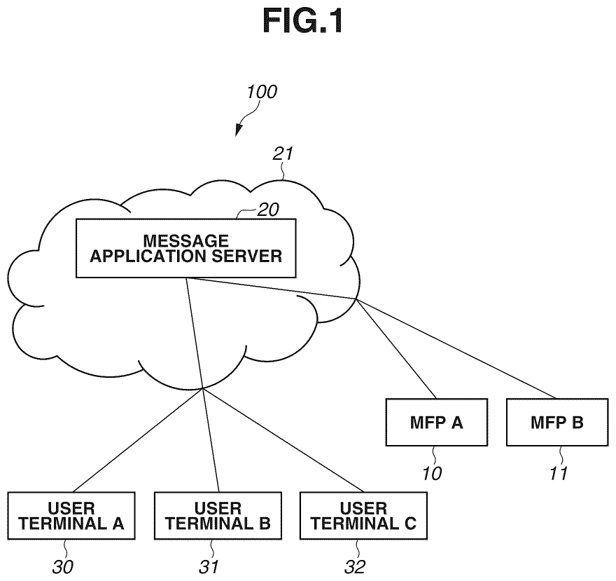

FIG. 1 is a diagram illustrating an example of a configuration of an image forming system 100 according to a first embodiment.

The image forming system 100 includes multi-function peripherals (MFPs) 10 and 11, user terminals 30 to 32, and a message application server 20. They are all connected via a network.

The MFPs 10 and 11 are image forming apparatuses that have the function of providing a notification on read images to the message application server 20. In the drawing, the two MFPs 10 and 11 are connected as an example, but any number of MFPs may be connected. The MFPs 10 and 11 have the same configuration, and the following description will focus on the MFP 10.

The message application server 20 is a cloud server located on a cloud 21, and is a server that provides services using a message application. The message application server 20 performs all processes related to message exchange, such as transmitting and receiving messages to and from the user terminals 30 to 32, and displaying the display screen for message transmission and reception.

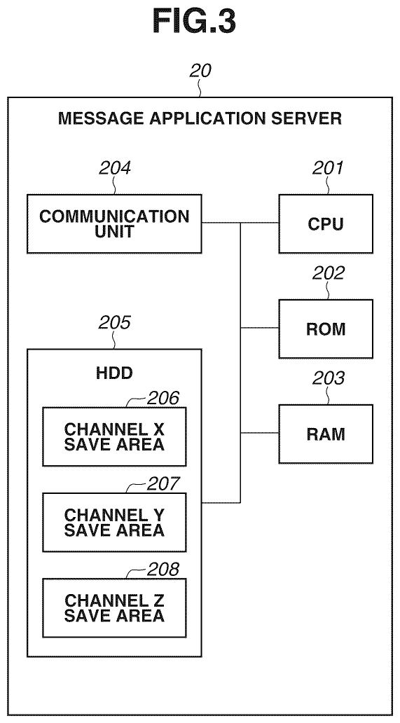

The user terminals 30 to 32 are information terminals such as smartphones, tablet terminals, and personal computers used by users of the message application service. In the example illustrated in FIG. 1, the three user terminals 30 to 32 are connected, but any number of terminals may be connected. Users operate the user terminals 30 to 32 to access the message application server 20 via the network, exchange messages with other users, and execute applications installed on a hard disk drive (HDD) 205 illustrated in FIG. 3. The user terminals 30 to 32 can have the same configuration, and the following description will focus on the user terminal 30.

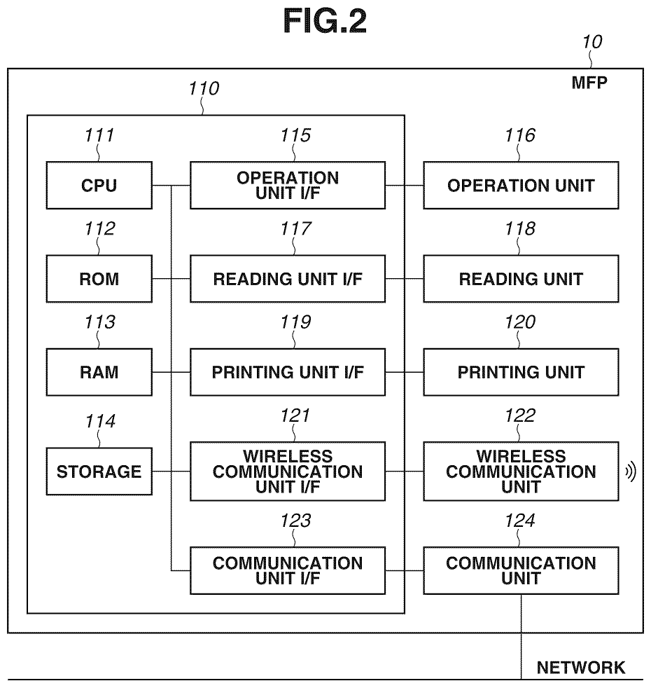

FIG. 2 is a diagram illustrating an example of a hardware configuration of the MFP 10. The MFP 10 includes a central processing unit (CPU) 111, a read only memory (ROM) 112, a random access memory (RAM) 113, a storage 114, an operation unit interface (I/F) 115, an operation unit 116, a reading unit I/F 117, a reading unit 118, a printing unit I/F 119, a printing unit 120, a wireless communication unit I/F 121, a wireless communication unit 122, a communication unit I/F 123, and a communication unit 124.

A control unit 110 including the CPU 111 controls the overall operations of the MFP 10. The CPU 111 reads control programs from the ROM 112 or the storage 114 into the RAM 113, and performs various types of control such as reading control and printing control.

The ROM 112 stores control programs that can be executed by the CPU 111. The ROM 112 also stores a boot program, font data, and the like.

The RAM 113 is a main memory and is used as a work area and a temporary storage area for developing various control programs stored in the ROM 112 and the storage 114.

The storage 114 stores image data, print data, various programs, various addresses, and various types of setting information such as automatic ordering settings. Possible media for use as the storage 114 include flash memory, auxiliary storage devices such as solid state drives (SSDs) and hard disc drives (HDDs), and embedded multimedia cards (eMMCs).

In the MFP 10 of the present embodiment, one CPU 111 executes processes illustrated in the flowcharts described below using one memory (RAM 113), but the present disclosure is not limited to this configuration. For example, the processes can be executed by pluralities of CPUs, RAMs, ROMs, and storages in cooperation. Also, some of the processes may be executed using hardware circuits such as application specific integrated circuits (ASICs) and field programmable gate arrays (FPGAs).

The operation unit I/F 115 connects the control unit 110 to the operation unit 116 including a display unit such as a touch panel and hard keys. The operation unit 116 displays information to the user and detects inputs from the user.

The reading unit I/F 117 connects the control unit 110 to the reading unit 118 such as a scanner. The reading unit 118 reads an image of a document, and the CPU 111 converts the image into image data such as binary data. The image data generated based on the image read by the reading unit 118 is transmitted to an external device or is printed on recording paper.

The printing unit I/F 119 connects the control unit 110 to the printing unit 120 such as a printer. The CPU 111 transfers image data (print data) stored in the RAM 113 to the printing unit 120 via the printing unit I/F 119. The printing unit 120 prints an image based on the transferred image data on recording paper fed from a paper feed cassette.

The wireless communication unit I/F 121 is an I/F for controlling the wireless communication unit 122, and connects the control unit 110 to external wireless devices via wireless communication. The user terminals 30 to 32 may be used as the external wireless devices.

The communication unit 124 connects the control unit 110 to the network. The communication unit I/F 123 allows the communication unit 124 to transmit image data and various types of internal device information to external devices on the network, and receive print data and network information from information processing devices on the network. Methods for transmitting and receiving data via the network include transmission and reception using electronic mail (E-mail), and file transmission using other protocols (for example, File Transfer Protocol (FTP), Server Message Block (SMB), Web-based Distributed Authoring and Versioning (WEBDAV), and the like). Furthermore, image data and various types of setting data can be transmitted and received over the network by accessing via HyperText Transfer Protocol (HTTP) communication.

FIG. 3 is a diagram illustrating an example of a hardware configuration of the message application server 20.

The message application server 20 includes a CPU 201, a ROM 202, a RAM 203, a communication unit 204, and an HDD 205. The HDD 205 includes a channel X save area 206, a channel Y save area 207, and a channel Z save area 208.

The CPU 201 reads control programs from the ROM 202 and various types of information from the HDD 205 into the RAM 203, and executes various processes for controlling the operations of the message application server 20.

The ROM 202 stores control programs.

The RAM 203 is used as a temporary storage area such as a main memory, a work area, and the like for the CPU 201.

The communication unit 204 exchanges data with various devices such as the user terminal 30. The communication unit 204 is assumed to communicate using a wired LAN.

The HDD 205 stores various types of data such as messages, images, channel information, and applications.

The HDD 205 has save areas 206 to 208 for saving data for individual channels. That is, data for channels X to Z is saved in the save areas 206 to 208 of the channels X to Z, respectively. Although FIG. 3 illustrates save areas for three channels, in reality, the HDD 205 has save areas corresponding to the number of channels.

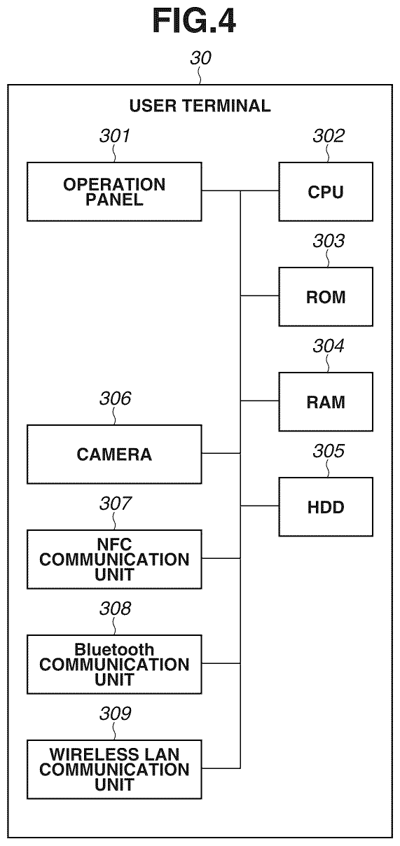

FIG. 4 is a diagram illustrating an example of a hardware configuration of the user terminal 30. The user terminal 30 in the present embodiment is assumed to be a device such as a smartphone or a tablet personal computer (PC), but may be any other device as long as it is an information processing device that can connect to a network using Wi-Fi communication or the like.

The user terminal 30 includes an operation panel 301, a CPU 302, a ROM 303, a RAM 304, an HDD 305, a camera 306, a Near Field Communication (NFC) communication unit 307, a Bluetooth (registered trademark) communication unit 308, and a wireless LAN communication unit 309.

The CPU 302 reads out control programs from the ROM 303 and various types of information from the HDD 305 into the RAM 304, and executes various processes for controlling the operations of the user terminal 30.

The ROM 303 stores the control programs.

The RAM 304 is used as a temporary storage area such as a main memory, work area, and the like for the CPU 302.

The HDD 305 stores various types of data such as photographs and electronic documents.

The operation panel 301 has a touch panel function capable of detecting a user's touch operation and displays various screens provided by the OS and an email send application. The operation panel 301 is also used to check information stored in the message application server 20. A user can input desired operation instructions to the user terminal 30 by performing touch input operations on the operation panel 301. The user terminal 30 may also include hardware keys (not illustrated), allowing the user to input operation instructions to the user terminal 30 using these hardware keys.

The camera 306 captures an image in response to a user's imaging instruction. The photograph captured by the camera 306 is stored in a predetermined area in the HDD 305. The user can also acquire information from a Quick Response (QR) code (registered trademark) read by the camera 306 using a program capable of analyzing QR codes.

The user terminal 30 can exchange data with various peripheral devices via the NFC communication unit 307, the Bluetooth communication unit 308, and the wireless LAN communication unit 309. The Bluetooth communication unit 308 of the user terminal 30 may be compatible with Bluetooth Low Energy.

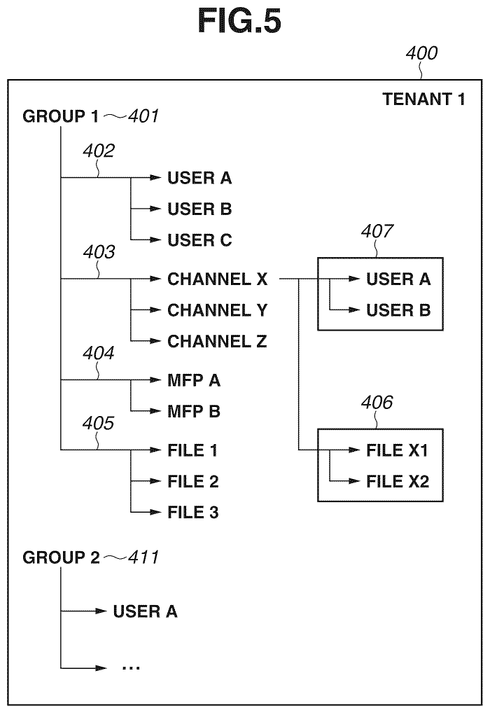

FIG. 5 is a diagram illustrating an example of tenant information 400 held by the message application server 20. In the present embodiment, the message application server 20 holds the tenant information 400. However, the tenant information 400 may also be held by another cloud server included in the cloud 21.

The tenant information 400 has one or more groups. In the example of FIG. 5, there are two groups 401 and 411. In the present embodiment, the description will be focused on the group 401, and thus details of the group 411 are omitted from FIG. 5. In reality, however, other groups including the group 411 have the same configuration as the group 401.

Each group has information on the constitution of the group. For example, the group 401 has user information 402, channel information 403, printer information 404, and file information 405.

The user information 402 indicates information on each user who belongs to the group 401.

The channel information 403 is information for grouping the user information 402, and holds a list 407 into which the user information corresponding to each channel is compiled. In the example of FIG. 5, the user information about a user A and the user information about a user B is linked to the channel X.

The printer information 404 indicates the MFPs 10 and 11. An application that uses the information about the group 401 can send various commands to any MFP with reference to the printer information 404.

The file information 405 is information on the files held in the group 401. The format of the files held as the file information 405 is arbitrary, and file information of various formats such as image data, video data, and audio data can be stored. Specifically, the file information 405 is saved in an arbitrary area of the HDD 205 in the message application server 20.

File information 406 linked to the channel X in the channel information 403 corresponds to the channel information 403. For example, a file X1 and a file X2 indicated in the file information 406 are set to be linked to the channel X. Each piece of the file information 406 linked to the channel X is given access authority that allows access only by the members of the channel X. Specifically, the file information 406 linked to the channel X is saved in the save area 206 provided in the HDD 205 in the message application server 20.

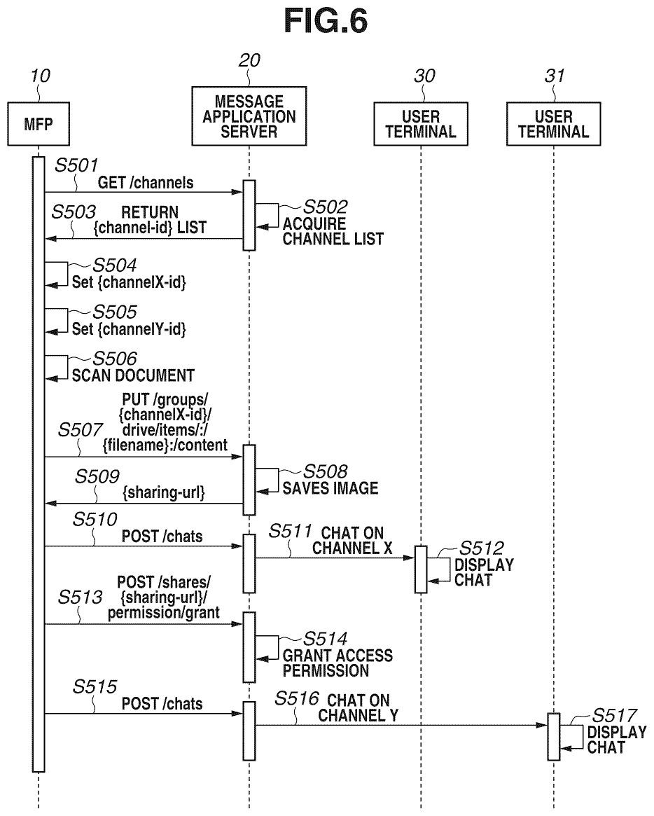

FIG. 6 is a sequence diagram illustrating an example of a sequence in which an image scanned by the MFP 10 is saved in the save area 206 of the channel X in the HDD 205 of the message application server 20 and save location information about the saved image is displayed in talk rooms on a plurality of channels. In this example, a user referring to the channel X uses the user terminal 30, and a user referring to the channel Y uses the user terminal 31.

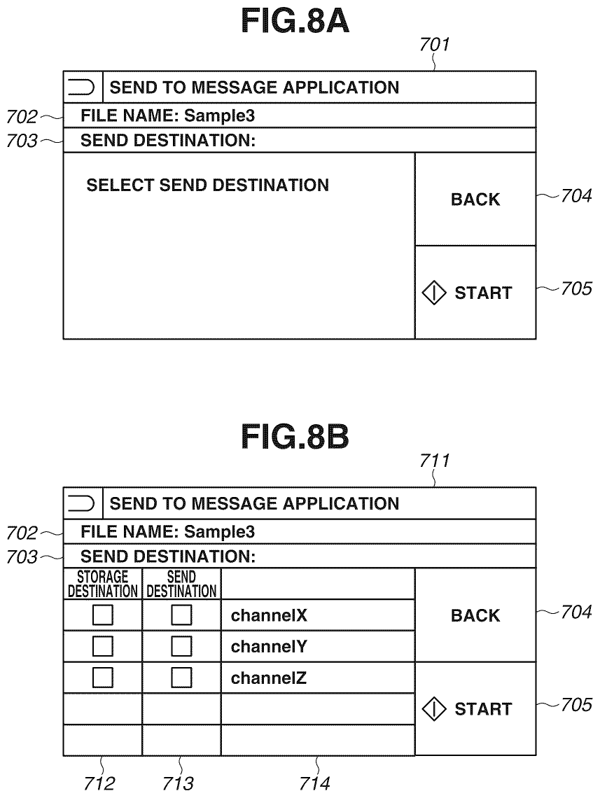

At the start of this sequence, a send screen 701 illustrated in FIG. 8A and FIG. 8B are displayed on the operation unit 116 of the MFP 10.

The send screen 701 includes a saved file name display area 702, a send destination display area 703, and an end command button 704 and a scan start button 705 for this sequence. Selecting the send destination display area 703 switches the screen displayed on the operation unit 116 of the MFP 10 to a channel selection screen 711. In the present embodiment, no default send destination is set, and nothing is displayed in the send destination display area 703. Instead, a default send destination may be set. In this case, the user who is the send destination last time may be selected as the default send destination. In the present embodiment, a default name is set in the saved file name display area 702, but the user may be able to freely enter a name.

The channel selection screen 711, like the send screen 701, has a saved file name display area 702, a send destination display area 703, an end command button 704, and a scan start button 705. A send destination channel candidate display area 714 displays channel candidates that can be selected as send destinations. In send destination checkboxes 713, the user can specify a chat destination by selecting a send destination checkbox corresponding to each channel. Two or more send destination checkboxes 713 can be selected. In storage destination checkboxes 712, a storage destination for the sent image data can be selected. For example, if the channel X is selected in the storage destination checkbox 712, the sent image data will be saved in the save area 206 of the channel X in the HDD 205 of the message application server 20. Only one storage destination checkbox 712 can be selected.

Returning to the description of the sequence diagram in FIG. 6, in step S501, the CPU 111 of the MFP 10 performs HTTP communication with the message application server 20 to request acquisition of channel information. An example of the command to be transmitted is “HTTP GET/channels”. By accessing this URL, the message application server 20 executes step S502.

In step S502, the CPU 201 of the message application server 20 generates a channel information list.

In step S503, the CPU 201 of the message application server 20 transmits the generated result to the MFP 10 as HTTP communication response information. Upon receipt of the channel information list in step S503, the MFP 10 controls the operation unit 116 to display the channel selection screen 711 with the send destination channel candidate display area 714 having been updated.

In steps S504 and S505, the user selects any number of channels for chatting about image information, from the screen 711 displayed on the operation unit 116 of the MFP 10. In the present embodiment, the channel X and the channel Y are specified in the send destination checkboxes 713, and the channel X is specified in the storage destination checkbox 712. When any channel is selected by the user, the MFP 10 stores channel-id of the selected channel. In the present embodiment, channelX-id, which is the channel-id of the channel X, is stored in step S504, and channelY-id, which is the channel-id of the channel Y, is stored in step S505. In the present embodiment, in order to store two pieces of channel information, two storage steps, steps S504 and S505, are executed. However, a number of storage steps corresponding to the number of channels may be performed.

In step S506, when the user selects the scan start button 705, the reading unit 118 of the MFP 10 reads the original image. The read information is converted into image data and saved in a temporary save area such as the storage 114.

In step S507, the CPU 111 of the MFP 10 performs HTTP communication with the message application server 20 to upload the image data to the save area 206 of the channel X. An example of the command to be transmitted is “HTTP PUT /groups/{channelX-id}/drive/items/:/{filename}:/content”. In the command, a filename is the file name set in the saved file name display area 702. Also, channelX-id is identification information related to the channel selected in step S504. By accessing this URL, the CPU 201 of the message application server 20 executes step S508.

In step S508, the CPU 201 of the message application server 20 saves the image data sent in step S507 in the specified save area, that is, the save area 206 of the channel X.

In a case where the image data is successfully saved, in step S509, the message application server 20 transmits information on the save location in the storage destination to the MFP 10 as response information of the HTTP communication.

In step S510, the CPU 111 of the MFP 10 performs HTTP communication with the message application server 20 to send a message to the chat room of the channel X. An example of the command to be transmitted is “HTTP POST/chats”. At this time, the CPU 111 also send the information on the save location of the image data acquired in step S509 as an HTTP communication message.

In step S511, the CPU 201 of the message application server 20 requests the user terminal 30, which refers to the timeline of the channel X, to display the content of the chat.

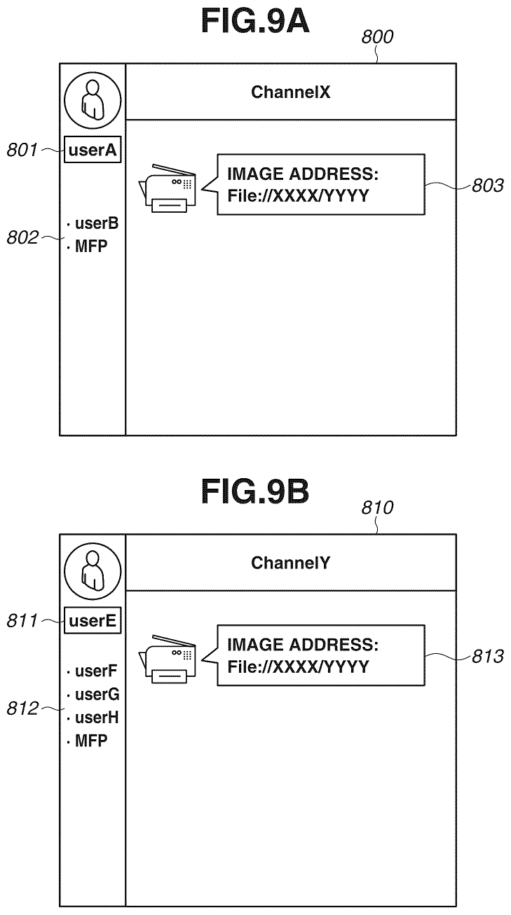

In step S512, the CPU 302 of the user terminal 30 displays the content of the chat on the operation panel 301. A chat screen 800 in FIG. 9A and FIG. 9B are examples of a chat screen of the channel X displayed on the operation panel 301 of the user terminal 30. A user 801 is the currently active user. A user 802 is another user who belongs to the channel X. A chat content 803 is the chat content about the save location information about the image saved in step S508. The image data can be viewed by referring to the save location information.

Returning to FIG. 6, in step S513, the CPU 111 of the MFP 10 performs HTTP communication with the message application server 20 to request access permission for the members of the channel Y to access the image data saved in step S508.

An example of the command to be transmitted is “POST/shares/{sharing-url}/permission/grant”, where sharing-url is the information on the save location of the image acquired in step S509. At this time, channelY-id, which is information indicating the channel Y, is also sent as an HTTP communication message.

In step S514, the CPU 201 of the message application server 20 grants access permissions for the members of the channel Y to access the file stored in step S508.

In step S515, the CPU 111 of the MFP 10 performs HTTP communication with the message application server 20 to transmit a message to the chat room of the channel Y. An example of the command to be transmitted is “HTTP POST/chats”. At this time, the CPU 111 also transmits information on the save location of the image data received in step S509 as an HTTP communication message.

In step S516, the CPU 201 of the message application server 20 requests the user terminal 31, which refers to the timeline of the channel Y, to display the content of the chat.

In step S517, the CPU 302 of the user terminal 31 displays the content of the chat on the operation panel 301. A chat screen 810 in FIG. 9A and FIG. 9B are examples of a chat screen of the channel Y displayed on the operation panel 301 of the user terminal 31. A user 811 is the currently active user. A user 812 is another user who belongs to the channel Y. A chat content 813 is the chat content about the save location information about the image saved in step S508. The image data can be viewed by accessing the storage location information.

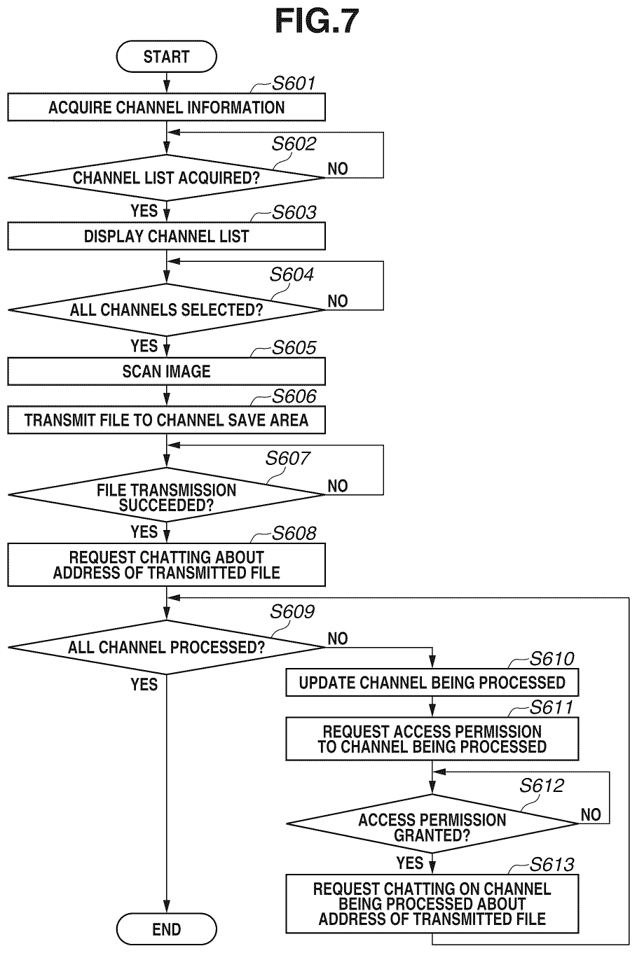

FIG. 7 is a flowchart illustrating an example of an operation flow of the MFP 10 in which an image scanned by the MFP 10 is saved in the HDD 205 for each user and the saved location information is displayed in talk rooms on a plurality of channels. The method for processing by the MFP 10 will be described below.

In step S601, the CPU 111 of the MFP 10 performs HTTP communication with the message application server 20 to request acquisition of a channel information list. Upon receipt of the request, the message application server 20 generates a channel information list and returns the generated channel information list to the MFP 10 as a response to the HTTP communication.

In step S602, the CPU 111 of the MFP 10 waits for the response to the HTTP communication made in step S601. In a case where the response has been already received (YES in step S602), the process proceeds to step S603. The response includes a list of channel information.

In step S603, the CPU 111 of the MFP 10 displays the channel selection screen 711 on the operation unit 116. The channel information acquired in step S602 is used in the send destination channel candidate display area 714 displayed here.

In step S604, the CPU 111 of the MFP 10 waits until the user selects all channels to which data should be sent. In a case where all channels are selected and the scan start button 705 is pressed (YES in step S604), the process proceeds to step S605. In the present embodiment, the channels X and Y are specified in the send destination checkboxes 713, and the channel X is specified in the storage destination checkbox 712.

In a case where a reading instruction is given by pressing the scan start button 705 in a state in which one channel X is selected as the storage destination channel in the storage destination checkbox 712 and the plurality of channels X and Y is selected as send destination channels in the send destination checkboxes 713, the CPU 111 of the MFP 10 causes the process to proceed to step S605.

In step S605, the reading unit 118 of the MFP 10 reads the original image. The read information is converted into image data and saved in a temporary save area such as the storage 114.

In step S606, the CPU 111 of the MFP 10 performs HTTP communication with the message application server 20 to upload the image data. That is, the CPU 111 of the MFP 10 uploads the image data generated by reading the original image to the save area 206 of the storage destination channel X of the message application server 20.

Upon receipt of the HTTP communication, the message application server 20 saves the target image data in the save area 206 linked to the channel information, and returns (transmits) the save location information (location information) about the image data to the MFP 10 as a response to the HTTP communication.

In step S607, the CPU 111 of the MFP 10 waits for the response to the HTTP communication made in step S606. In a case where the response has been already received (YES in step S607), the process proceeds to step S608. The CPU 111 of the MFP 10 receives from the message application server 20 the response that includes the save location information about the saved data.

In step S608, the CPU 111 of the MFP 10 performs HTTP communication with the message application server 20 to transmit a message to the chat room of the channel X. At this time, the CPU 111 also transmits, as an HTTP communication message, the save location information about the image data included in the HTTP communication response information acquired in step S607.

That is, the CPU 111 of the MFP 10 transmits a message including the save location information about the image data to the chat room of the send destination channel X, which is the same channel as the storage destination channel X, without requesting the message application server 20 to grant permission for members of the send destination channel X, which is the same channel as the storage destination channel X, to access the image data.

Upon receipt of the HTTP communication, the message application server 20 requests the user terminal 30, which refers to the timeline of the channel X, to display the content of the chat. That is, upon receipt of the message from the MFP 10, the message application server 20 performs control so that the message is to be displayed in the chat room of the send destination channel X.

In step S609, the CPU 111 of the MFP 10 determines whether a chat send request has been sent to all the channels selected in steps S603 and S604. In a case where a chat send request has been sent to all the channels (YES in step S609), the process is ended. In a case where there is any channel to which a chat send request has not yet been sent (NO in step S609), the process proceeds to step S610.

In step S610, the CPU 111 of the MFP 10 updates the channel information currently being processed. In the present embodiment, when the process has reached step S610 for the first time, the channel currently being processed is switched from the channel X to the channel Y.

In step S611, the CPU 111 of the MFP 10 performs HTTP communication with the message application server 20 to request access permission for the members of the channel Y to access the saved image data.

The CPU 111 of the MFP 10 requests the message application server 20 to grant access permission for the members of the send destination channel Y, which is a channel different from the storage destination channel X, to access the image data.

In step S612, the CPU 111 of the MFP 10 waits for a response to the HTTP communication of the access permission request sent to the message application server 20 in step S612. In a case where a response has been received (YES in step S612), the process proceeds to step S613.

In step S613, the CPU 111 of the MFP 10 performs HTTP communication with the message application server 20 to send a message to the chat room of the channel Y. At this time, the CPU 111 also transmits, as an HTTP communication message, the save location information about the image data included in the HTTP communication response information acquired in step S607.

That is, the CPU 111 of the MFP 10 transmits a message including the save location information about the image data to the chat room of the send destination channel Y, which is a channel different from the storage destination channel X.

Upon receipt of the HTTP communication, the message application server 20 requests the user terminal 31, which refers to the timeline of the channel Y, to display the content of the chat. That is, upon receipt of the message from the MFP 10, the message application server 20 performs control so that the message is to be displayed in the chat room of the send destination channel Y. After this step 613, the process returns to step S609.

With the above configuration, the original image read by the MFP 10 can be saved in the message application server 20, and the save location information about the original image can be presented in the chats on the timelines of the channel X and channel Y. In addition, while the image information is saved in the save area 206 of the channel X, the members of the channel Y can access the image information.

### Second Embodiment

In relation to a second embodiment, a configuration will be described in which image save location information is presented in a chat on another channel, a channel Z, using the history of image information sent to a channel X stored in an MFP 10. As a premise for the description of the second embodiment, the image save location information and storage destination channel notified by the MFP 10 in the sequence of FIG. 6 are saved in a storage 114 of the MFP 10.

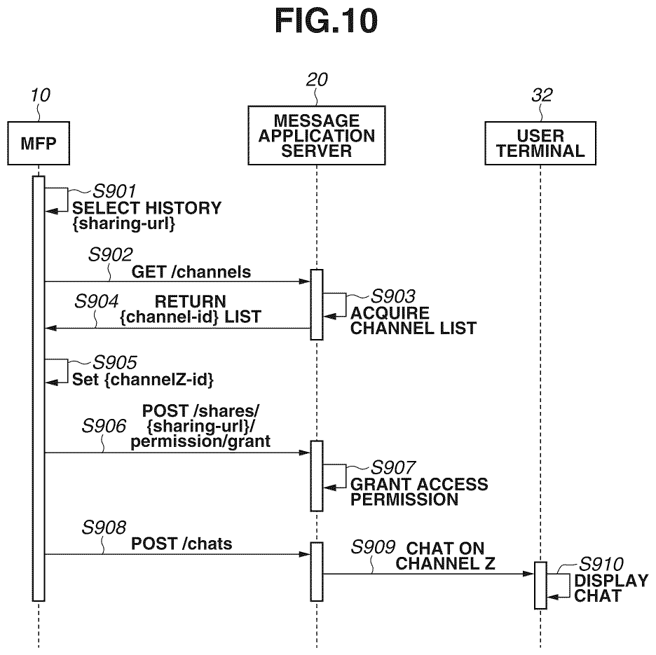

FIG. 10 is a sequence diagram illustrating an example of a sequence in which, when history information on sending to the channel X saved in the storage 114 of the MFP 10 is selected, image save location information in the history is displayed in the talk room of the channel Z. In this example, a user who refers to the channel X uses a user terminal 30, and a user who refers to the channel Z uses a user terminal 32.

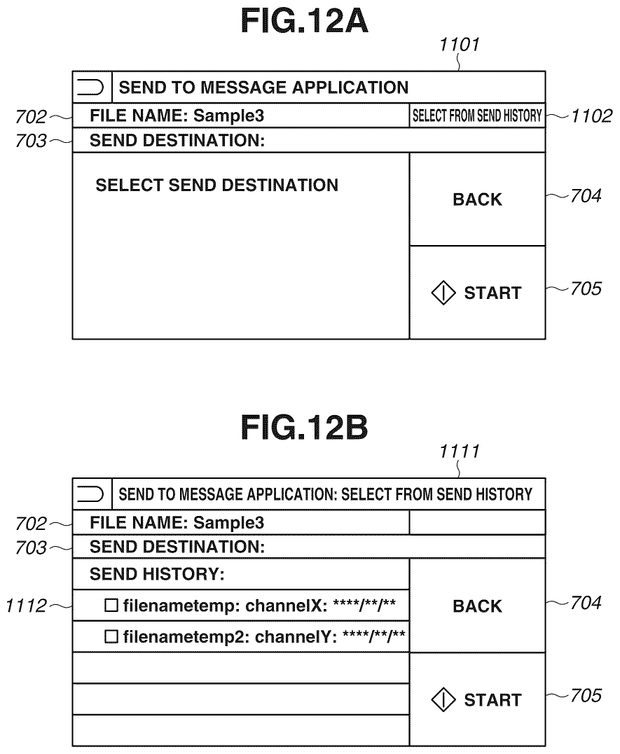

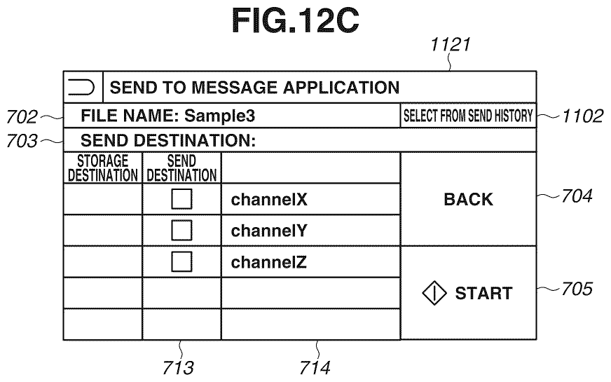

At the same time as start of the sequence, a send screen 1101 illustrated in FIG. 12A, FIG. 12B, and FIG. 12C are displayed on an operation unit 116 of the MFP 10. In a case where the present embodiment is applied, the send screen 1101 is also displayed, instead of a send screen 701, at the start of the send sequence illustrated in FIG. 6.

The send screen 1101 has, like the send screen 701, a saved file name display area 702, a send destination display area 703, an end command button 704, and a scan start button 705. The operations of these are identical to those of the first embodiment, so description thereof will be omitted. A button 1102 is a button for selecting from the send history, and pressing the button 1102 switches to a screen 1111.

The screen 1111 for selecting from the send history has, like the send screen 1101, a saved file name display area 702, a send destination display area 703, an end command button 704, and a scan start button 705. A send history list 1112 is a list that displays the history of images sent to each channel that is saved in the storage 114 of the MFP 10. The send history list 1112 presents the file names displayed in the saved file name display area 702 at the time of sending the files, the image information storage destination channels, and the sending dates and times. When any one of these items is set, the saved file name display area 702 is updated.

A channel selection screen 1121 is a channel selection screen switched from the screen 1111. A configuration of the screen 1121 is identical to the channel selection screen 711 of the first embodiment, except that it does not have the storage destination checkboxes 712 but has the button 1102 for selecting from send history. The operations of the items are identical to those already described, so description thereof will be omitted in this section.

Returning to FIG. 10, in step S901, the user presses the button 1102 to switch to the screen 1111, and selects any history in the send history list 1112. Thereafter, the user presses the send destination display area 703 to switch to the screen 1121.

In step S902, a CPU 111 of the MFP 10 performs HTTP communication with a message application server 20 to request acquisition of channel information. An example of the command to be transmitted is “HTTP GET/channels”. By accessing this URL, the message application server 20 executes step S903.

In step S903, a CPU 201 of the message application server 20 generates a channel information list.

In step S904, the CPU 201 of the message application server 20 transmits the generated result to the MFP 10 as HTTP communication response information. In step S904, upon receipt of the channel information list, the MFP 10 displays the channel selection screen 1121 on the operation unit 116, with a send destination channel candidate display area 714 having been updated.

In step S905, the user selects a channel for chatting about image save location information, from the screen 1121 displayed on the operation unit 116 of the MFP 10. In the present embodiment, the user selects the channel Z in a send destination checkbox 713. When any channel is selected by the user, the MFP 10 stores the channel-id of the selected channel. In the present embodiment, channel Z-id, which is the channel-id of the channel Z, is stored. In the present embodiment, one storage step is executed to store one piece of channel information, but the storage step may be performed a number of times corresponding to the number of channels.

In step S906, the CPU 111 of the MFP 10 performs HTTP communication with the message application server 20 to request access permission for the members of the channel Z to access the image data. An example of the command to be transmitted is “POST/shares/{sharing-url}/permission/grant”. In the command, sharing-url is the save location information about the image saved in the history. At this time, the CPU 111 also sends channelZ-id, which is information indicating the channel Z, as an HTTP communication message.

In step S907, the CPU 201 of the message application server 20 grants access permission for the members of the channel Z to the file.

In step S908, the CPU 111 of the MFP 10 performs HTTP communication with the message application server 20 to transmit a message to the chat room of the channel Z. An example of the command to be transmitted is “HTTP POST/chats”. At this time, the CPU 111 also sends the save location information about the image data saved in the history as an HTTP communication message.

In step S909, the CPU 201 of the message application server 20 requests the user terminal 32, which refers to the timeline of the channel Z, to display the content of the chat.

In step S910, the CPU 302 of the user terminal 32 displays the content of the chat on the operation panel 301. The image data can be viewed by accessing the save location information presented in the chat.

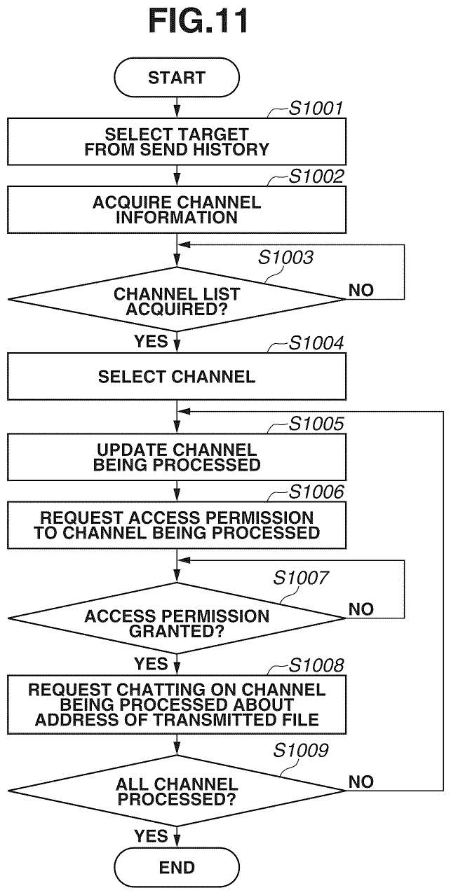

FIG. 11 is a flowchart illustrating an example of an operation flow of the MFP 10 in which an image scanned by the MFP 10 is saved in the HDD 205 for each user and the save location information is displayed in the talk rooms of a plurality of channels.

In step S1001, the CPU 111 of the MFP 10 detects a target selected in the send history list 1112. That is, the CPU 111 of the MFP 10 detects image data selected from the send history list 1112. The send history list 1112 is a list of image data that has been uploaded to the message application server 20 in the past.

In step S1002, the CPU 111 of the MFP 10 performs HTTP communication with the message application server 20 to request acquisition of a channel information list. Upon receipt of the HTTP communication, the message application server 20 generates a channel information list and returns the generated channel information list to the MFP 10 as a response to the HTTP communication.

In step S1003, the CPU 111 of the MFP 10 waits for the response to the HTTP communication performed in step S1002. In a case where the response has already been received (YES in step S1003), the process proceeds to step S1004.

In step S1004, the CPU 111 of the MFP 10 displays the channel selection screen 1121 on the operation unit 116. The send destination channel candidate display area 714 displayed on the operation unit 116 uses the channel information acquired in step S1003. The user selects the channel Z in the send destination checkbox 713 on the channel selection screen 1121.

When an instruction to send the image data selected in step S1001 to the other send destination channel Z is given by pressing the start button 705, the CPU 111 of the MFP 10 causes the process to proceed to step S1005.

In step S1005, the CPU 111 of the MFP 10 updates the channel information currently being processed. When the process has reached step S1005 for the first time, any channel is set as the first channel currently being processed. In the present embodiment, the channel currently being processed is set as the channel Z.

In step S1006, the CPU 111 of the MFP 10 performs HTTP communication with the message application server 20 to request access permission for the members of the channel Z to access the image data.

That is, the CPU 111 of the MFP 10 requests the message application server 20 to grant access permission for the members of the other send destination channel Z to access the image data.

In step S1007, the CPU 111 of the MFP 10 waits for a response to the HTTP communication of the access permission request sent to the message application server 20 in step S1006. In a case where the response has been already received (YES in step S1007), the process proceeds to step S1008.

In step S1008, the CPU 111 of the MFP 10 performs HTTP communication with the message application server 20 to send a message to the chat room of the channel Z. At this time, the CPU 111 also sends the save location information about the image data saved in the history as an HTTP communication message.

That is, the CPU 111 of the MFP 10 transmits a message including the save location information about the image data to the chat room of the other send destination channel Z.

Upon receipt of the HTTP communication, the message application server 20 requests the user terminal 32, which refers to the timeline of the channel Z, to display the content of the chat.

In step S1009, the CPU 111 of the MFP 10 determines whether a chat message send request has been made to all of the channels selected in step S1004. In a case where a chat message send request has been sent to all of the channels (YES in step S1009), the process is ended. In a case where there is any channel to which a chat send request has not yet been sent (NO in step S1009), the process proceeds to step S1005. In the present embodiment, since no channels other than channel Z have been selected, the process is ended immediately.

With the above configuration, it is possible to, using the history of image information sent to the channel X saved in the MFP 10, chat with another channel, the channel Z, about the save location information of the image.

As above, according to the first and second embodiments, image data generated by the MFP 10 reading an original image can be sent to the chat rooms of a plurality of channels and made available for viewing. In sending image data to the plurality of channels, there is no need to send image data from the MFP 10 or to perform an operation to request access permission a plurality of times. In addition, there is no need to prepare a copy of the image data for each channel in the message application server 20.

According to the present disclosure, it is possible to send a message including the save location information about image data to each of the chat rooms of a plurality of channels.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-196161, filed Nov. 8, 2024, which is hereby incorporated by reference herein in its entirety.

What is claimed is:

1. An image forming apparatus comprising:
at least one memory storing instructions; and
at least one processor that, upon execution of the stored instructions, configures the at least one processor to operate as:
an uploading unit configured to, in a case where a reading instruction is given with a plurality of channels being selected as send destination channels, upload image data generated by reading an original image to a message application server and receive save location information about the image data from the message application server; and
a sending unit configured to send a message including the save location information about the image data to each of chat rooms of the plurality of send destination channels of the message application server.

2. The image forming apparatus according to claim 1, wherein, in a case where a reading instruction is given with one channel being selected as a storage destination channel and a plurality of channels being selected as send destination channels, the uploading unit uploads image data generated by reading an original image to a save area of the storage destination channel of the message application server, and receives save location information about the image data from the message application server.

3. The image forming apparatus according to claim 2,
wherein the sending unit does not request the message application server to grant access permission for a member of a send destination channel that is a same channel as the storage destination channel to access the image data,
wherein the sending unit sends a message including the save location information about the image data to a chat room of the send destination channel that is the same channel as the storage destination channel, and
wherein after requesting the message application server to grant access permission for a member of a send destination channel that is different from the storage destination channel to access the image data, the sending unit sends a message including the save location information about the image data to a chat room of the send destination channel that is different from the storage destination channel.

4. The image forming apparatus according to claim 1, wherein in a case where an instruction is given to send image data selected from among image data uploaded to the message application server in the past to another send destination channel, the sending unit sends a message including save location information about the image data to a chat room of the other send destination channel of the message application server.

5. The image forming apparatus of claim 4, wherein after requesting the message application server to grant access permission for a member of the other send destination channel to access the image data, the sending unit sends a message including the save location information about the image data to the chat room of the other send destination channel.

6. A processing method of an image forming apparatus, the processing method comprising:
in a case where a reading instruction is given with a plurality of channels being selected as send destination channels, uploading image data generated by reading an original image to a message application server and receiving save location information about the image data from the message application server; and
sending a message including the save location information about the image data to each of chat rooms of the plurality of send destination channels of the message application server.

7. A non-transitory computer readable storage medium storing a program for causing an information processing apparatus to perform a method, the method comprising:
in a case where a reading instruction is given with a plurality of channels being selected as send destination channels, uploading image data generated by reading an original image to a message application server and receiving save location information about the image data from the message application server; and
sending a message including the save location information about the image data to each of chat rooms of the plurality of send destination channels of the message application server.
